(19) United States
(12) Patent Application Publication
(10) Pub. No.: US 2026/0163204 A1
(43) Pub. Date: Jun. 11, 2026

(54) SECONDARY BATTERY AND METHOD OF MANUFACTURING SECONDARY BATTERY

(71) Applicant: SAMSUNG SDI CO., LTD., Yongin-si (KR)

(72) Inventors: Inseop BYUN, Yongin-si (KR); Byunghuy CHO, Yongin-si (KR); Junho BYEON, Yongin-si (KR); Hyojin LIM, Yongin-si (KR)

(21) Appl. No.: 19/231,007

(22) Filed: Jun. 6, 2025

(30) Foreign Application Priority Data
Dec. 6, 2024 (KR) 10-2024-0180149

(51) Int. Cl. H01M 50/533; H01M 10/04; H01M 50/103; H01M 50/105; H01M 50/119; H01M 50/474; H01M 50/55

(52) U.S. Cl. CPC H01M 50/533; H01M 10/049; H01M 50/103; H01M 50/105; H01M 50/119; H01M 50/474; H01M 50/55

(57) ABSTRACT

A secondary battery includes an electrode assembly including a positive electrode, a separator, and a negative electrode. A case body accommodates the electrode assembly and has an opening. A cover is coupled to the case body. A terminal is connected to the case body extending through a surface of the case body. An electrode tab connects the electrode assembly to the terminal. The electrode tab is bent to include a first connecting portion connected to the electrode assembly, and a second connecting portion extending from the bend and connected to the terminal.

### CROSS-REFERENCE TO RELATED APPLICATION

The present application claims priority to and the benefit of Korean Application No. 10-2024-0180149, filed on Dec. 6, 2024, in the Korean Intellectual Property Office, the entire disclosure of which is incorporated by reference herein.

### BACKGROUND

### Field

Aspects of embodiments of the present disclosure relate to a secondary battery and method for manufacturing the secondary battery.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In conventional secondary batteries, the electrode assembly is connected to the electrode terminal using an electrode tab. According to a known arrangement, the electrode tab is bent into a V shape, and then the electrode tab is bent a second time during the process of accommodating the electrode assembly in the case. In this case, the energy density of the secondary battery is reduced due to the space occupied by the electrode tabs that are folded multiple times.

The above information disclosed in this Background section is for enhancement of understanding of the background of the present disclosure, and therefore, it may contain information that does not constitute related (or prior) art.

### SUMMARY

Embodiments of the present disclosure provide a secondary battery and method for manufacturing same.

These and other aspects and features of the present disclosure will be described in or will be apparent from the following description of embodiments of the present disclosure.

A secondary battery of the present disclosure includes an electrode assembly including a positive electrode, a separator, and a negative electrode, a case body accommodating the electrode assembly and having an opening, a cover coupled to the case body, a terminal connected to the case body by extending through a surface of the case body, and an electrode tab connecting the electrode assembly to the terminal, wherein the electrode tab is bent so as to include a first connecting portion connected to the electrode assembly and a second connecting portion extending from the bend and connected to the terminal.

According to an embodiment, the case body is formed from stainless steel.

According to an embodiment, the first connecting portion extends along a longitudinal direction of the case body, and the second connecting portion extends along a thickness direction of the case body.

According to an embodiment, the first connecting portion is connected to a first surface of the electrode assembly that faces the cover.

According to an embodiment, the second connecting portion is spaced apart from the second surface of the electrode assembly that faces the terminal.

According to an embodiment, a separation distance between a surface of the electrode assembly adjacent to the terminal, and the second connecting portion is 2 mm or less.

According to an embodiment, a length of the second connecting portion is shorter than a length of the first connecting portion.

According to an embodiment, the terminal includes a first terminal connected to the positive electrode, and a second terminal connected to the negative electrode, and the electrode tab includes a first electrode tab connecting the first terminal to the positive electrode and a second electrode tab connecting the second terminal to the negative electrode.

According to an embodiment, the first terminal and the second terminal are disposed on a same surface of the case body.

According to an embodiment, the secondary battery further includes an insulator disposed between the first terminal and the case body.

A method for manufacturing a secondary battery of the present disclosure includes preparing an electrode assembly including a positive electrode, a separator, and a negative electrode, and a case body having an opening, coupling a terminal to the case body by extending through a surface of the case body, connecting a first connecting portion of an electrode tab to the electrode assembly, and connecting a second connecting portion of the electrode tab to the terminal, accommodating the electrode assembly in the case body by making a single fold between the first connecting portion and the second connecting portion, and coupling a cover to the case body to cover the opening.

According to an embodiment, the electrode tab includes a first surface and a second surface opposite to the first surface, and the connecting of the first connecting portion includes connecting the electrode assembly to the first surface of the electrode tab, and connecting the terminal to the second surface of the electrode tab.

According to an embodiment, the connecting of the first connecting portion includes bending at least a part of the first connecting portion before connecting the second connecting portion to the terminal and connecting the second connecting portion to the terminal in a state where at least a part of the first connecting portion is bent.

According to an embodiment, the first connecting portion is bent at an angle of 0 to 90 degrees relative to the second connecting portion.

According to an embodiment, wherein, the bending of at least a part of the first connecting portion is in a first direction, and the accommodating of the electrode assembly includes bending the first connecting portion in a second direction opposite to the first direction to accommodate the electrode assembly in the case body.

According to an embodiment, a length of the second connecting portion is shorter than a length of the first connecting portion.

According to an embodiment, the case body is formed from stainless steel.

According to an embodiment, the terminal includes a first terminal connected to the positive electrode, and a second terminal connected to the negative electrode, and the electrode tab includes a first electrode tab connecting the first terminal to the positive electrode and a second electrode tab connecting the second terminal to the negative electrode.

According to an embodiment, the coupling of the terminal includes disposing the first terminal and the second terminal on a same surface of the case body.

According to an embodiment, the method further includes disposing an insulator in a space between the first terminal and the case body.

According to some embodiments of the present disclosure, by connecting an electrode assembly and a terminal using an electrode tab with a single fold (bend), the separation distance between the terminal and the electrode assembly may be minimized. Accordingly, the capacity of the electrode assembly may be increased so that the energy density of the secondary battery is improved.

According to some embodiments of the present disclosure, by bending the first connecting portion of the electrode tab in a reverse direction to be accommodated in the case body, the second connecting portion may be easily connected to the terminal.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is an exploded perspective view showing an example of a secondary battery according to an embodiment of the present disclosure.

FIG. 2 is a drawing showing an example of a secondary battery according to an embodiment of the present disclosure.

FIG. 3 is a cross-sectional view showing an example of a secondary battery according to an embodiment of the present disclosure.

FIG. 4 is a drawing showing an enlarged example of an electrode tab of a secondary battery according to an embodiment of the present disclosure.

FIG. 5 is a drawing showing an example of connecting an electrode assembly and a terminal according to an embodiment of the present disclosure.

FIG. 6 is a cross-sectional view showing an example of an insulator disposed between a first terminal and a case body according to an embodiment of the present disclosure.

FIG. 7 is a flowchart illustrating an example of a secondary battery manufacturing method according to an embodiment of the present disclosure.

FIG. 8 is a drawing showing an example of connecting an electrode assembly and a terminal to an electrode tab according to an embodiment of the present disclosure.

FIG. 9 is a drawing showing an example of accommodating an electrode assembly in a case body according to an embodiment of the present disclosure.

FIG. 10 is a drawing showing an example of connecting an electrode assembly and a terminal to an electrode tab according to an embodiment of the present disclosure.

FIG. 11 is a drawing showing an example of accommodating an electrode assembly in a case body according to an embodiment of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when a layer or element is referred to as being “between” two layers, it can be the only layer between the two layers, or one or more intervening layers may also be present. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of local patent laws.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

In this disclosure, the sizes and relative sizes of layers and regions depicted in the drawings may be exaggerated for clarity of explanation. That is, the sizes shown in the drawings are only for convenience and are not limited thereto. Additionally, identical reference numerals refer to identical components throughout the specification.

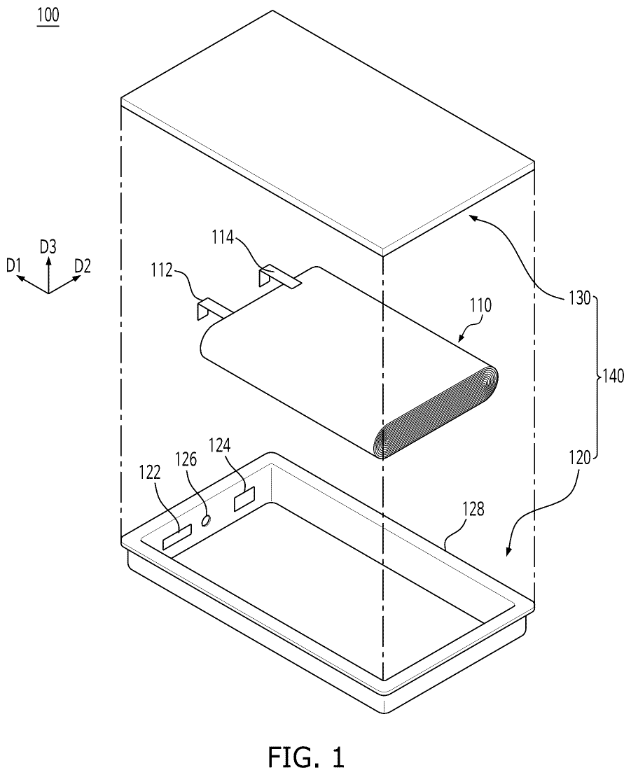

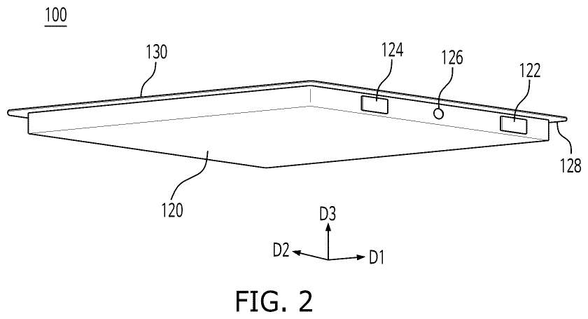

FIG. 1 is an exploded perspective view showing an example of a secondary battery 100 according to an embodiment of the present disclosure, and FIG. 2 is a drawing showing an example of a secondary battery 100 according to an embodiment of the present disclosure.

In an embodiment, the secondary battery 100 may include an electrode assembly 110 including a positive electrode, a separator, and a negative electrode, and a case 140 that accommodates the electrode assembly 110. Here, the case 140 may include a case body 120 that accommodates the electrode assembly 110 and has opening (e.g., opening in the D3 direction of the case body 120), and a cover 130 that is mounted to cover the opening and coupled with the case body 120. The electrode assembly 110 may be wound or laminated with a separator, which is an insulator, interposed between positive and negative electrodes. The case 140 illustrated in FIG. 1 includes stainless steel SUS, and the secondary battery 100 may be a SUS can type secondary battery. But embodiments of the present disclosure are not limited to this example. For example, the case 140 may be formed of a conductive metal such as aluminum, an aluminum alloy, or nickel-plated steel to form the overall appearance of the secondary battery 100.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.
intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-αDα (}0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L1 is Mn, Al, or a combination thereof.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to an embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

In an embodiment, the electrode assembly 110 may have a positive electrode tab 112 connected to a side of the positive electrode, and a negative electrode tab 114 connected to a side of the negative electrode. The positive electrode tab 112 and the negative electrode tab 114 may be connected by welding the tabs to non-coated portions of the positive and negative electrodes or may be formed by punching out the non-coated portions of the positive and negative electrodes. In the wound state, the positive electrode tab 112 and the negative electrode tab 114 may be disposed in parallel with a gap therebetween. However, the positive electrode tab 112 and the negative electrode tab 114 may be disposed on different side surfaces of the secondary battery.

The case body 120 may include a positive electrode terminal 122 and a negative electrode terminal 124. Here, the positive electrode terminal 122 may be electrically connected to the positive electrode tab 112 of the electrode assembly 110, and the negative electrode terminal 124 may be electrically connected to the negative electrode tab 114 of the electrode assembly 110. Additionally, the positive electrode terminal 122 and the negative electrode terminal 124 may be connected to the case body 120 by extending through surface of the case body 120 (for example, extending through the surface in the D1 direction as shown in FIG. 1). The positions of the positive electrode terminal 122 and the negative electrode terminal 124 according to the present disclosure are not limited to the positions depicted in FIG. 1 and various alternatives are possible.

In an embodiment, the positive electrode tab 112 and the negative electrode tab 114 corresponding to the electrode tabs of the present disclosure may have a single folded structure. Here, a single folded structure may refer to a structure formed by bending only one time. In still other words, the single folded structure refers to a structure in which an object is deformed at a specific angle at one point or part by a folding operation, and there is no folds at other points or parts of the structure. The single folded structure may be distinguished from a multi-folded structure. A multi-folded structure may refers a structure in which an object has folds at multiple points or parts. The positive electrode tab 112 and the negative electrode tab 114 have a single folded structure, thereby improving structural consistency and manufacturing efficiency.

Specifically, each of the positive electrode tab 112 and the negative electrode tab 114 may include a first connecting portion connected to the electrode assembly 110, and a second connecting portion bent and connected at an end of the first connecting portion, with the second connecting portions being connected to the positive electrode terminal 122 and the negative electrode terminal 124. That is, each of the positive electrode tab 112 and the negative electrode tab 114 may be bent into an L shape to connect the electrode assembly 110 to the positive electrode terminal 122 and the negative electrode terminal 124, respectively. Examples of electrode tabs are described in detail below.

In an embodiment, the case body 120 may include an electrolyte solution injection port 126. The electrolyte solution injection port 126 may be a hole formed on one surface of the case body 120 (for example, a surface of the case body 120 such that the hole extends in the D1 direction). The injection port 126 may be formed to allow the electrolyte solution to be injected into the case of the secondary battery 100 after the case body 120 and the cover 130 are joined and sealed. The electrolyte solution injection port 126 according to the present disclosure is illustrated as being located between the positive electrode terminal 122 and the negative electrode terminal 124. But the present disclosure is not limited to this example and various alternatives are possible.

In an embodiment, the case body 120 may include a receiving portion and a flange 128. Specifically, a receiving portion for receiving an electrode assembly 110 may be formed in an approximately central region of the case body 120 by press-processing or the like. Additionally, a flange 128 extending outwardly from the top of the receiving portion may be formed. The flange 128 may be formed in four directions on the upper edge of the receiving portion.

The case body 120 and the cover 130 may be joined to form the exterior of the secondary battery 100. For example, the case body 120 and the cover 130 may be metal-bonded by welding, brazing, soldering, etc. In this case, the flange 128 of the case body 120 and the edge of the cover 130 may be joined. Additionally, after the case body 120 and the cover 130 are joined, at least a part of the flange 128 may be cut using a laser to improve the energy density of the secondary battery 100.

The secondary battery 100 may be a lithium battery cell, a sodium battery cell, etc. However, the scope of the present disclosure is not limited to these examples, and the secondary battery 100 may be other types of batteries that are repeatedly provide electricity by charging and discharging. In an embodiment, the secondary battery 100 is a lithium battery cell that may be used in an electric vehicle EV because it has excellent life characteristics and high-rate characteristics. For example, the secondary battery 100 may be used in hybrid vehicles such as plug-in hybrid electric vehicles (PHEV). Additionally, lithium battery cells may be used in other applications that require a large amount of power storage. For example, lithium battery cells may be used in electric bicycles, power tools, etc.

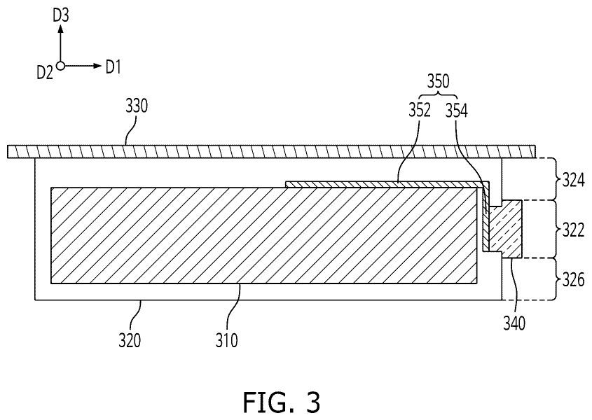

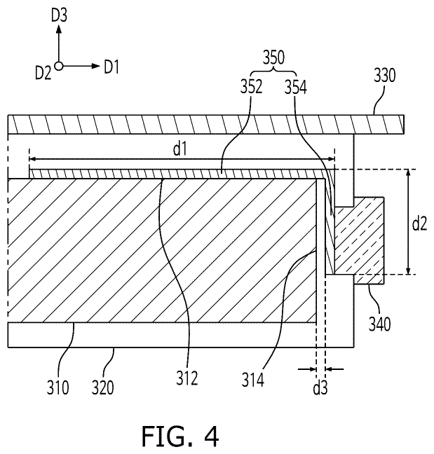

FIG. 3 is a cross-sectional view showing an example of a secondary battery according to an embodiment of the present disclosure, and FIG. 4 is a drawing showing an enlarged example of an electrode tab 350 of a secondary battery according to an embodiment of the present disclosure.

Referring to FIG. 3, the secondary battery may include an electrode assembly 310 including a positive electrode, a separator, and a negative electrode, a case body 320 that accommodates the electrode assembly 310 and has an opening, a cover 330 covering the opening of the case body 320. A terminal 340 may be coupled to the case body 320 by extending through a side surface of the case body 320. The secondary battery also includes an electrode tab 350 that connects the electrode assembly 310 to the terminal 340 and has a single folded structure. Here, the case body 320 may formed from stainless steel, but the present disclosure is not limited thereto.

In an embodiment, the electrode tab 350 may include a first connecting portion 352 connected to the electrode assembly 310, and a second connecting portion 354 bent and connected at an end of the first connecting portion 352 and connected to the terminal 340. The first connecting portion 352 may extend along the longitudinal direction (e.g., D1 direction) of the case body 320. Additionally, the second connecting portion 354 may extend along the thickness direction (e.g., D3 direction) of the case body 320.

In an embodiment, the first connecting portion 352 may be connected to a first surface of the electrode assembly 310 that faces the cover 330. Here, the first surface of the electrode assembly 310 means a side of the electrode assembly 310 that is closest to the cover 330 (for example, a surface in the D3 direction of the electrode assembly 310 that is adjacent to the cover 330). Additionally, the end of the first connecting portion 352 may be bent and connected to the second connecting portion 354. That is, one end of the first connecting portion 352 may be connected to the electrode assembly 310, and the end of the first connecting portion 352 may be connected to the second connecting portion 354.

In an embodiment, the second connecting portion 354 may be connected to a terminal 340 extending through the case body 320. In this arrangement, the second connecting portion 354 may be spaced apart from the second surface of the electrode assembly 310 facing the terminal 340. Here, the second surface of the electrode assembly 310 means the surface of the electrode assembly 310 that is closest to the terminal 340 (for example, the surface of the electrode assembly 310 in the D1 direction that is adjacent to the terminal 340). The second surface of the electrode assembly 310 is a surface perpendicular to the first surface of the electrode assembly 310.

In an embodiment, a side surface of the case body 320 may include a first region 322 corresponding to the terminal 340, a second region 324 positioned adjacent to the cover 330 with respect to the first region 322, and a third region 326 positioned opposite sto the second region 324 with respect to the first region 322. Here, the second connecting portion 354 may overlap with the first region 322 and the second region 324 in the longitudinal direction (e.g., D1 direction) of the case body 320. Additionally, the second connecting portion 354 may not overlap with the third region 326 in the longitudinal direction of the case body 320.

Referring to FIG. 4, the length d2 of the second connecting portion 354 may be shorter than the length d1 of the first connecting portion 352. Additionally, the distance d3 between a surface of the electrode assembly 310 adjacent to the terminal 340 and the second connecting portion 354 may be 2 mm or less. As such, the separation distance d3 may be less than the separation distance between the electrode assembly and the terminal in a conventional V-shaped bent electrode tab 350. Although not shown in FIGS. 3 and 4, a spacer including an insulating material to prevent a short circuit may be disposed between one surface of the electrode assembly 310 adjacent to the terminal 340 and the second connecting portion 354.

In FIGS. 3 and 4, the first connecting portion 352 and the second connecting portion 354 are illustrated as being bent about a 90° angle. But the present disclosure is not limited to this example, and the first connecting portion 352 and the second connecting portion 354 may be bent in a curve to prevent cracks in the electrode tab 350.

With the described and depicted configuration, the separation distance between the terminal and the electrode assembly may be minimized by connecting the electrode assembly and the terminal using the electrode tab having a single folded structure. Accordingly, the capacity of the electrode assembly may be increased so that the energy density of the secondary battery is improved.

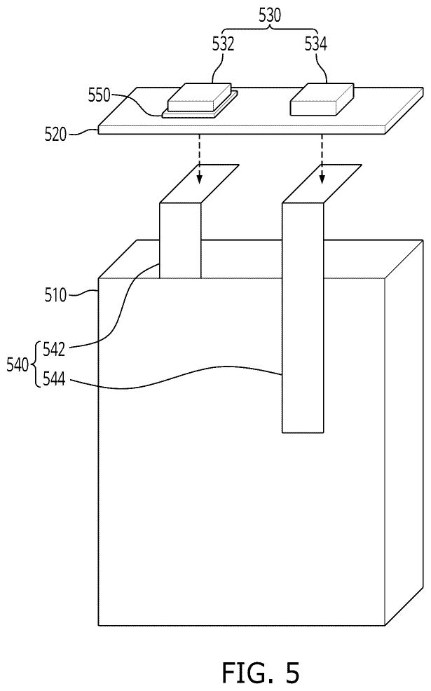

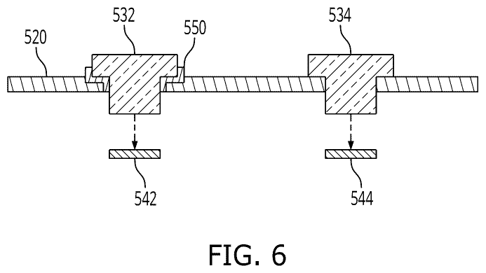

FIG. 5 is a drawing showing an example of connecting an electrode assembly 510 and a terminal 530 according to an embodiment of the present disclosure, and FIG. 6 is a cross-sectional view showing an example of an insulator 550 disposed between a first terminal 532 and a case body 520 according to an embodiment of the present disclosure.

Referring to FIG. 5, the electrode assembly 510 may include a positive electrode, a separator, and a negative electrode. Additionally, a terminal 530 may be coupled to the case body 520 by extending through a side surface of the case body 520 that accommodates the electrode assembly 510. In this case, the electrode tab 540 may electrically connect the electrode assembly 510 and the terminal 530. For convenience, in FIG. 5 illustration of the remaining parts of the case body 520 except for one side surface of the case body 520 where the terminal 530 is formed are omitted.

In an embodiment, the electrode tab 540 may have a single folded structure. Specifically, the electrode tab 540 may include a first connecting portion connected to the electrode assembly 510 and a second connecting portion bent and connected at an end of the first connecting portion and connected to the terminal 530.

In an embodiment, the terminal 530 may include a first terminal 532 connected to the positive electrode of the electrode assembly 510 and a second terminal 534 connected to the negative electrode of the electrode assembly 510. Additionally, the electrode tab 540 may include a first electrode tab 542 connected to the first terminal 532, and a second electrode tab 544 connected to the second terminal 534. Here, the first terminal 532 and the second terminal 534 may be positioned side by side and spaced apart on the same surface of the case body 520.

In an embodiment, the electrode assembly 510 may be formed by winding a positive electrode, a separator, and a negative electrode. In this case, the first electrode tab 542 may be connected to the positive electrode disposed at the outermost end of the electrode assembly 510. Similarly, the second electrode tab 544 may be connected to the negative electrode positioned at the outermost end of the electrode assembly 510.

Referring to FIG. 6, an insulator 550 may be disposed between the first terminal 532 and the case body 520. The insulator 550 may include an insulating material to block electrical connection between the case body 520 and the first terminal 532. The second terminal 534 may be electrically connected by being contact with the case body 520. In this arrangement, the case body 520 may have a negative polarity. In addition, the first terminal 532 and the second terminal 534 may be formed to extend beyond the outer surface of the case body 520. But the disclosure is not limited, and the outer surface of the first terminal 532 and/or the second terminal 534 may be formed to be level with the outer surface of the case body 520.

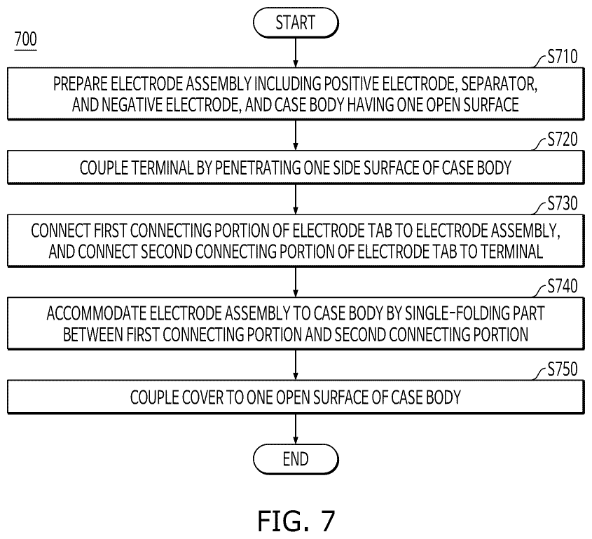

FIG. 7 is a flowchart illustrating an example of a secondary battery manufacturing method 700 according to an embodiment of the present disclosure. The method of manufacturing a secondary battery 700 may begin by preparing an electrode assembly including a positive electrode, a separator, and a negative electrode, and a case body having an opening S710. Here, the case body may be formed from stainless steel. Additionally, a terminal may be connected to the case body by extending through a side surface of the case body S720.

Thereafter, the first connecting portion of the electrode tab may be connected to the electrode assembly and the second connecting portion of the electrode tab may be connected to the terminal S730. Here, the electrode tab may include a first surface and a second surface opposite the first surface. An electrode assembly may be connected to a first surface of the electrode tab, and a terminal may be connected to a second surface of the electrode tab.

Thereafter, the electrode assembly may be accommodated in the case body by making a single fold between the first connecting portion and the second connecting portion S730. Here, the length of the second connecting portion may be shorter than the length of the first connecting portion. Additionally, a cover may be coupled to the case body to seal the opening S740.

In an embodiment, before connecting the second connecting portion to the terminal, at least a part of the first connecting portion may be bent in the first direction. Here, the angle at which at least a part of the first connecting portion is bent in the first direction may be from 0 degrees to 90 degrees. Additionally, the second connecting portion may be connected to the terminal while the first connecting portion is bent. The first connecting portion may be folded in a second direction opposite to the first direction to accommodate the electrode assembly in the case body. Here, the bent (folded) portion may be a point or part that distinguishes the first connecting portion from the second connecting portion. In other words, the first connecting portion may be distinguished from the second connecting portion at the bent portion. The bending in the first direction and the bending in the second direction may occur at the same point or part.

The terminal may include a first terminal connected to the positive electrode and a second terminal connected to the negative electrode. In this case, the first terminal and the second terminal may be disposed on the same surface of the case body. Additionally, an insulator may be disposed between the first terminal and the case body. The electrode tab may include a first electrode tab connected to the first terminal and a second electrode tab connected to the second terminal.

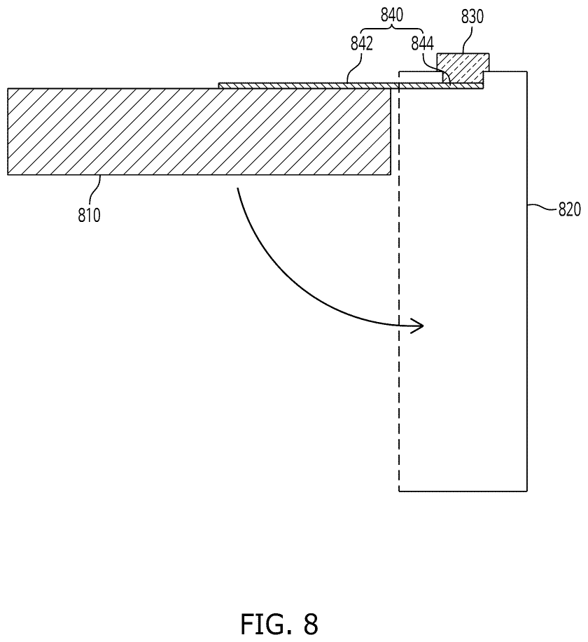

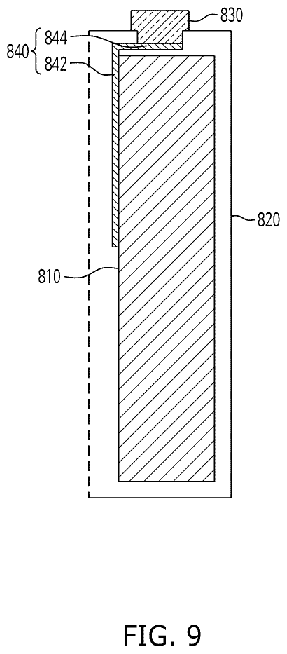

FIG. 8 is a drawing showing an example of connecting an electrode assembly 810 and a terminal 830 to an electrode tab 840 according to an embodiment of the present disclosure, and FIG. 9 is a drawing showing an example of accommodating an electrode assembly 810 in a case body 820 according to an embodiment of the present disclosure.

Referring to FIG. 8, an electrode assembly 810 including a positive electrode, a separator, and a negative electrode, and a case body 820 with an opening may be prepared. Additionally, a terminal 830 may be coupled to the case body 820 by extending through a side surface of the case body 820. Here, the case body 820 may formed from, but is not limited to, stainless steel.

In an embodiment, the first connecting portion 842 of the electrode tab 840 may be connected to the electrode assembly 810 by welding or the like. Additionally, the second connecting portion 844 of the electrode tab 840 may be connected to the terminal 830 by welding or the like. Here, the second connecting portion 844 may extend through the case body 820 and be connected to a surface of the terminal 830 located on the inside of the case body 820.

In an embodiment, the electrode tab 840 may include a first surface and a second surface opposite the first surface. An electrode assembly 810 may be connected to the first surface of the electrode tab 840, and a terminal 830 may be connected to the second surface of the electrode tab 840. That is, the electrode assembly 810 and the terminal 830 may be connected to different surfaces of the electrode tab 840.

Referring to FIG. 9, a single bend may be formed between the first connecting portion 842 and the second connecting portion 844. When the first connecting portion 842 and the second connecting portion 844 of the electrode tab 840 are prepared horizontally, the portion between the first connecting portion 842 and the second connecting portion 844 may be bent at approximately 90 degrees. Then the electrode assembly 810 may be accommodated in the case body 820.

In FIG. 9, the first connecting portion 842 and the second connecting portion 844 are illustrated as being bent vertically. But the present disclosure is not limited to this example, and the portion between the first connecting portion 842 and the second connecting portion 844 may be bent in a curve to prevent cracks in the electrode tab 840.

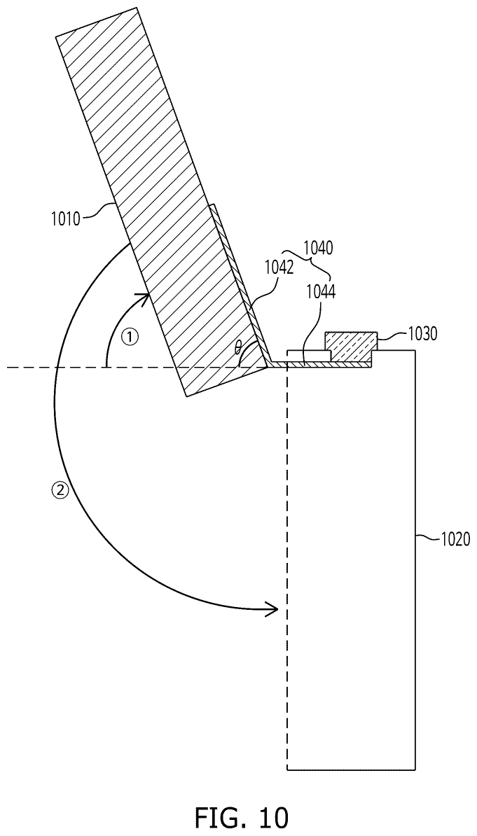

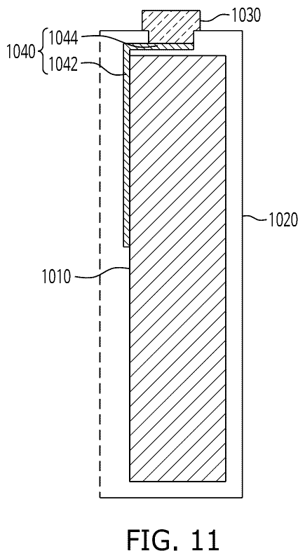

FIG. 10 shows an example of connecting an electrode assembly 1010 and a terminal 1030 to an electrode tab 1040 according to an embodiment of the present disclosure, and FIG. 11 is a drawing showing an example of accommodating an electrode assembly 1010 in a case body 1020 according to an embodiment of the present disclosure.

Referring to FIG. 10, an electrode assembly 1010 including a positive electrode, a separator, and a negative electrode, and a case body 1020 with an opening may be prepared. A terminal 1030 may be coupled to the case body 1020 by extending through a side surface of the case body 1020. Here, the case body 1020 may be formed from, but is not limited to, stainless steel.

The first connecting portion 1042 of the electrode tab 1040 may be connected to the electrode assembly 1010 by welding or the like. Similarly, the second connecting portion 1044 of the electrode tab 1040 may be connected to the terminal 1030 by welding or the like. Here, the second connecting portion 1044 may extend into the case body 1020 and be connected to one surface of the terminal 1030 located on the inside of the case body 1020.

The electrode tab 1040 may include a first surface and a second surface opposite the first surface. An electrode assembly 1010 may be connected to the first surface of the electrode tab 1040, and a terminal 1030 may be connected to the second surface of the electrode tab 1040. That is, the electrode assembly 1010 and the terminal 1030 may be connected to different surfaces of the electrode tab 1040.

At least a part of the first connecting portion 1042 may be bent in the first direction before the second connecting portion 1044 is connected to the terminal 1030. The second connecting portion 1044 may then be connected to the terminal while at least a part of the first connecting portion 1042 is bent. Here, the angle at which the first connecting portion 1042 is bent in the first direction may be from 0 degrees to 90 degrees.

Referring to FIG. 11, a single bend may be formed between the first connecting portion 1042 and the second connecting portion 1044. Specifically, the first connecting portion 1042 may be bent in a second direction opposite to the first direction. In this case, the angle at which the first connecting portion 1042 is bent in the second direction may be 90 to 180 degrees. Accordingly, the electrode assembly 1010 may be accommodated in the case body 1020.

In FIGS. 10 and 11 the first connecting portion 1042 and the second connecting portion 1044 are illustrated as being bent at an angle or bent vertically. But embodiments of the present disclosure not limited to this example, and the first connecting portion 1042 and the second connecting portion 1044 may be bent in a curved shape to prevent cracks in the electrode tab 1040.

By this configuration, the second connecting portion may be easily connected to the terminal by bending the first connecting portion of the electrode tab in the reverse direction to be accommodated in the case body.

Although the present disclosure has been described above with respect to embodiments thereof, the present disclosure is not limited thereto. Various modifications and variations can be made thereto by those skilled in the art within the spirit of the present disclosure.

1. A secondary battery comprising:
an electrode assembly including a positive electrode, a separator, and a negative electrode;
a case body accommodating the electrode assembly and having an opening;
a cover coupled to the case body to seal cover the opening;
a terminal connected to the case body by extending through a surface of the case body; and
an electrode tab connecting the electrode assembly to the terminal,
wherein the electrode tab is bent so as to include:
a first connecting portion connected to the electrode assembly; and
a second connecting portion extending from the bend and connected to the terminal.

2. The secondary battery as claimed in claim 1, wherein the case body is formed from stainless steel (SUS).

3. The secondary battery as claimed in claim 1, wherein the first connecting portion extends along a longitudinal direction of the case body, and
wherein the second connecting portion extends along a thickness direction of the case body.

4. The secondary battery as claimed in claim 1, wherein the first connecting portion is connected to a first surface of the electrode assembly that faces the cover.

5. The secondary battery as claimed in claim 1, wherein the second connecting portion is spaced apart from the second surface of the electrode assembly that faces the terminal.

6. The secondary battery as claimed in claim 5, wherein a separation distance between a surface of the electrode assembly adjacent to the terminal and the second connecting portion is 2 mm or less.

7. The secondary battery as claimed in claim 1, wherein a length of the second connecting portion is shorter than a length of the first connecting portion.

8. The secondary battery as claimed in claim 1, wherein the terminal includes a first terminal connected to the positive electrode and a second terminal connected to the negative electrode, and
wherein the electrode tab includes a first electrode tab connecting the first terminal to the positive electrode and a second electrode tab connecting the second terminal to the negative electrode.

9. The secondary battery as claimed in claim 8, wherein the first terminal and the second terminal are disposed on a same surface of the case body.

10. The secondary battery as claimed in claim 8, further comprising an insulator disposed between the first terminal and the case body.

11. A method for manufacturing a secondary battery, the method comprising:
preparing an electrode assembly including a positive electrode, a separator, and a negative electrode, and a case body having an opening;
coupling a terminal to the case body by extending through a surface of the case body;
connecting a first connecting portion of an electrode tab to the electrode assembly and connecting a second connecting portion of the electrode tab to the terminal;
accommodating the electrode assembly in the case body by making a single fold between the first connecting portion and the second connecting portion; and
coupling a cover to the case body to cover the opening.

12. The method as claimed in claim 11, wherein the electrode tab includes a first surface and a second surface opposite to the first surface, and
wherein the connecting of the first connecting portion includes:
connecting the electrode assembly to the first surface of the electrode tab; and
connecting the terminal to the second surface of the electrode tab.

13. The method as claimed in claim 11, wherein the connecting of the first connecting portion includes:
bending at least a part of the first connecting portion before connecting the second connecting portion to the terminal; and
connecting the second connecting portion to the terminal in a state where at least a part of the first connecting portion is bent.

14. The method as claimed in claim 13, wherein the first connecting portion is bent at an angle of 0 to 90 degrees relative to the second connecting portion.

15. The method as claimed in claim 13, wherein, the bending of at least a part of the first connecting portion is in a first direction, and
wherein the accommodating of the electrode assembly includes bending the first connecting portion in a second direction opposite to the first direction to accommodate the electrode assembly in the case body.

16. The method as claimed in claim 11, wherein a length of the second connecting portion is shorter than a length of the first connecting portion.

17. The method as claimed in claim 11, wherein the case body is formed from stainless steel.

18. The method as claimed in claim 11, wherein the terminal includes a first terminal connected to the positive electrode, and a second terminal connected to the negative electrode, and
wherein the electrode tab includes a first electrode tab connecting the first terminal to the positive electrode and a second electrode tab connecting the second terminal to the negative electrode.

19. The method as claimed in claim 18, wherein the coupling of the terminal includes disposing the first terminal and the second terminal on a same surface of the case body.

20. The method as claimed in claim 18, further comprising disposing an insulator in a space between the first terminal and the case body.
